(19) United States
(12) Patent Application Publication
(10) Pub. No.: US 2024/0202580 A1
(43) Pub. Date: Jun. 20, 2024

(54) COMPUTER-IMPLEMENTED METHOD FOR ASSESSING STRUCTURE-BORNE NOISE

(71) Applicant: Dr. Ing. h.c. F. Porsche Aktiengesellschaft, Stuttgart (DE)

(72) Inventors: Sophie Schwandt, Berlin (DE); Johannes Maerkle, Berlin (DE)

(21) Appl. No.: 18/084,199

(22) Filed: Dec. 19, 2022

(51) Int. Cl. G06N 20/00

(52) U.S. Cl. CPC G06N 20/00

(57) ABSTRACT

A computer-implemented method for assessing structure-borne noise includes recording (S3) training data sets of structure-borne noise data. Each of the training data sets is each recorded while a force acts on a component, and the structure-borne noise data depend on the force. The method proceeds by training (S5) an artificial intelligence using the training data sets. The method then includes recording (S7) plural first assessment data sets of structure-borne noise data, assessing the first assessment data sets using the trained artificial intelligence and subsequently recording at least one first calibration data set of structure-borne noise data. The method continues by training (S8) the artificial intelligence using the at least one first calibration data set.

### CROSS-REFERENCE TO RELATED APPLICATION

This application claims priority on German Patent Application No 10 2022 104 304.5 filed Feb. 23, 2022, the entire disclosure of which is incorporated herein by reference.

### BACKGROUND

### Field of the Invention

The invention relates to a computer-implemented method for assessing structure-borne noise.

### Related Art

Structure-borne noise sensors are used in the manufacture of motor vehicles to record structure-borne noise data. These data are assessed to detect defective components and/or a defective assembly of components. For example, DE 10 2019 003 679 A1 discloses a use of a machine-learning algorithm to assess engine abnormalities.

By contrast, the problem addressed by the present invention is to create a method and a system that adapts to changing circumstances.

### SUMMARY OF THE INVENTION

A method according to one aspect of the invention records training data sets of structure-borne noise data. This can be done, for example, with sensors. The training data sets are recorded while a force acts on a component. The noise data is dependent on the force, and each training data set can correspond to a component and a changing force.

An artificial intelligence is trained using the training data sets. For example, this can be supervised, unsupervised, or partially supervised. In particular, supervised training in the context of this description is understood to mean that a particular parameter is assigned to the training data sets, for example, prior to training. This can be done, for example, by a user. The parameter can be that the training data set in question belongs to a defect-free or a defective component. In the context of this description, a defective component is also understood to mean that the respective component is not assembled correctly, for example, erroneously or insufficiently.

In this way, the artificial intelligence is trained to detect defective components, regardless of the cause of the defect. The reason for this is that the training of artificial intelligence is not aimed at the detection of certain defects, but rather generally at the detection of deviations between data sets that belong to defect-free components and data sets that belong to defective components. In a further embodiment of the invention, however, it is possible that the artificial intelligence is trained to detect certain defect causes.

In addition, a plurality of first assessment data sets of structure-borne noise data is recorded. This can be done, for example, with the same sensors as the recording of the training data sets, or with other sensors. It is possible that the first assessment data sets are not recorded under completely the same conditions as the training data sets. For example, the training data sets can be recorded under conditions that have particularly little impact on the recorded structure-borne noise data. For example, the first assessment data sets can be recorded on a production line or at the end of a production line. In so doing, vibrations occurring in the production line can affect the recording of the first assessment data sets.

The assessment data sets are assessed using the trained artificial intelligence.

Thereafter, at least a first calibration data set of structure-borne noise data is recorded. This can be done, for example, with the same sensors as the recording of the first assessment data sets, or with other sensors. It is possible that the at least one first calibration data set is recorded under not completely the same conditions as the first assessment data sets and/or as the training data sets. For example, the at least one first calibration data set can be recorded under conditions that have particularly little impact on the recorded structure-borne noise data.

The artificial intelligence is trained using the at least one first calibration data set. This is done although artificial intelligence has already been trained on the training data sets. It is particularly advantageous, because the artificial intelligence can thus be adapted to any unnoticed changes in conditions and/or components.

According to one embodiment, prior to training of the artificial intelligence using the training data sets, the training data sets can be classified by the artificial intelligence into clusters based on a quality of the training data sets. Only training data sets that have a quality above a limit are used for training the artificial intelligence.

According to one embodiment, after the training, second assessment data sets of structure-borne noise data can be recorded using the at least one first calibration data set and assessed using the artificial intelligence. Thus, the second assessment data sets can be assessed with the artificial intelligence that is adapted to any changed circumstances and/or components.

According to one embodiment, in the assessment the first and/or second assessment data sets are assessed by the artificial intelligence as being associated with defect-free components or as being associated with defective components. Thus, the artificial intelligence can assess the respective assessment data sets as belonging to defective components, regardless of the cause or the type of defect. The training with data sets that belong to defect-free components enables unknown interference variables to be detected as interferences.

In one embodiment, only structure-borne noise data from defect-free components can be used to record the at least one first calibration data set.

In one embodiment, a first type of component can each be used when recording the training data sets, the first and second assessment data sets, and the at least one first calibration data set. In the context of this description, the type of component is understood to mean a specific design. For example, a plurality of the first type of component can always be manufactured the same way in a single series production. In particular, this can always be the same component of a single vehicle model.

After the assessment of the second assessment data sets, second calibration data sets are each recorded using a second type of component. By contrast, no second type of component is used when recording the training data sets, the first and second assessment data sets, and the at least one first calibration record. The artificial intelligence is trained using the second calibration data sets.

This embodiment is particularly advantageous for adapting the already trained artificial intelligence to another purpose, namely for the assessment of noise data of components of the second type. This is very possible when the components of the first type have only relatively small differences compared to the components of the second type. For example, when the first type of component is used for a first motor vehicle model for a particular purpose, and the second type of component is used for the same purpose in a second motor vehicle model, the training with the second calibration data sets can be sufficient for assessing the structure-borne noise data of the second type of component. Advantageously, a completely new training of the artificial intelligence or another artificial intelligence can then be omitted.

According to some embodiments, third assessment data sets of structure-borne noise data can be recorded using a second type of component. The third assessment data sets can be assessed after training the artificial intelligence with the second calibration data sets. For example, the assessment can comprise the third assessment data sets being assessed as belonging to defective or defect-free components.

According to some embodiments, the components can be components of motor vehicles. More particularly, all components mentioned in this description may be components of motor vehicles.

According to one embodiment, in the assessment of the first, second, and/or third assessment data sets, a movement of the respective component relative to another component enables an assessment of a strength of the respective component, and/or the presence of an imbalance.

The system comprises a digital electronic storage medium and a digital electronic processing unit. The processing unit can be a digital signal processor, for example. Instructions are stored in the storage medium. The processing unit is configured to read out and execute the instructions. The processing unit further is designed to carry out a method according to one embodiment of the invention when executing the instructions.

Further features and advantages of the invention become apparent from the following description of a preferred exemplary embodiment with reference to the enclosed illustrations. The same reference numerals are used for the same or similar features and for features having the same or similar functions.

### BRIEF DESCRIPTION OF THE DRAWINGS

FIG. 1 is a schematic block diagram of a training of an artificial intelligence according to one embodiment of the invention.

FIG. 2 is a schematic block diagram of a use of trained artificial intelligence for assessing structure-borne noise.

### DETAILED DESCRIPTION

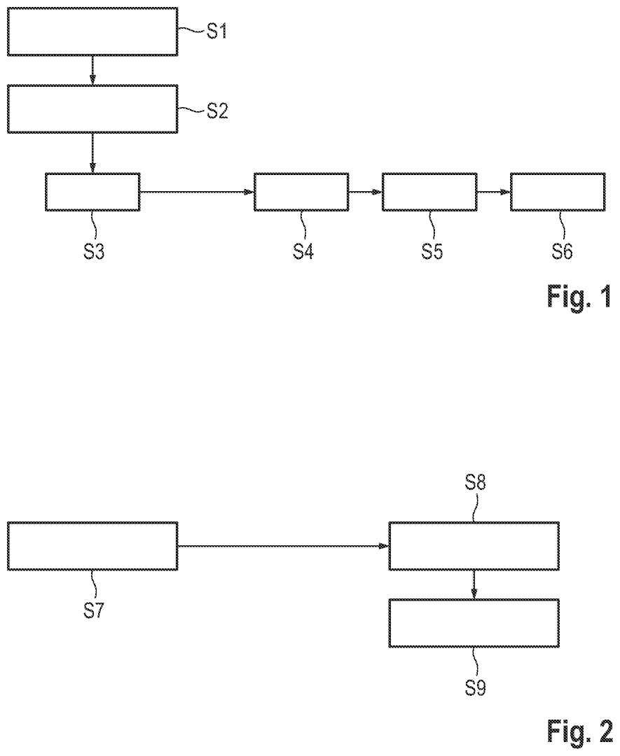

At the outset, it should be understood that should be understood that the elements and functions described herein and shown in FIGS. 1 and 2 may be implemented in various forms of hardware, software or combinations thereof. These elements may be implemented in a combination of hardware and software on one or more appropriately programmed general-purpose devices, which may include a processor, memory and input/output interfaces. The term “connected” as used or implied herein mean directly connected to or indirectly connected with through one or more intermediate components. Such intermediate components may include both hardware and software-based components.

Those skilled in the art will appreciate that the Figures represent conceptual views of illustrative circuitry embodying the principles of the disclosure and/or also represent various processes that may be represented substantially in computer readable media and so executed by a computer or processor, whether or not such computer or processor is explicitly shown.

The functions described herein may be carried out with a control unit that may be provided through the use of dedicated hardware as well as hardware capable of executing software in association with appropriate software. In one embodiment, some or all of the functions may be performed by at least one processor, such as a computer or an electronic data processor, digital signal processor or embedded micro-controller, in accordance with code, such as computer program code, software, and/or integrated circuits that are coded to perform such functions, unless indicated otherwise. When provided by a processor, the functions may be provided by a single dedicated processor, by a single shared processor, or by a plurality of individual processors, some of which may be shared. Moreover, the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage. Other hardware, conventional and/or custom, may also be included in the control unit, such as a memory, input/output interfaces, a wireless transceiver, analog-to-digital converters, etc.

In a step S1, a sensor for recording structure-borne noise data is first arranged and/or fastened at a suitable position to record structure-borne noise waves of a component to be tested. In an optional step S2, the sensor can be connected to a control unit. The control unit is configured so as to control and possibly also synchronize the recording of training data sets from structure-borne noise data recorded by the sensor.

In step S3, the recording of the training data sets is carried out from the structure-borne noise data recorded by the sensor. In an optional step S4, the training data sets can be classified into clusters based on their quality. This can be done by an artificial intelligence to be trained and can be unsupervised learning.

In step S5, the artificial intelligence is trained with the training data sets. When step S4 is performed, it is possible that only training data sets having a quality above a limit will be used for the training. In step S6, a trained model used by the artificial intelligence is stored in a digital memory.

When using the artificial intelligence to assess structure-borne noise data, first assessment data sets of structure-borne noise data are recorded in step S7. This can be carried out with the structure used in step S3. However, it is also possible that a different sensor can be used to record the first assessment data sets. In particular, it is possible that step S7 is performed within a production line or at the end of a production line, by contrast to step S3. In this case, the recording of the first assessment data sets can be affected by vibrations and noises that were not present when the training data sets were recorded. Nevertheless, the artificial intelligence can assess the first assessment data sets. In particular, the artificial intelligence assesses whether the first assessment data sets belong to defect-free or defective components.

After a certain number of assessments of the first assessment data sets, the artificial intelligence is trained in step S8 with at least one first calibration data set. It is possible to perform step S8 regularly. By training with the at least one first calibration data set, the artificial intelligence is adapted to potentially changing environmental conditions or to components that are changed due to changed production processes.

It is also possible to train the artificial intelligence with a plurality of second calibration data sets in step S8. In that case, for example, the second calibration data sets can relate to a different type of component than the training data sets. By training with the second calibration data sets, the artificial intelligence can be adapted so as to assess assessment data sets that relate to components of the other type. This is very possible, in particular, when the components of the second calibration data sets and the training data sets differ relatively little. In this case, step S8 can replace the complete training of the artificial intelligence for assessing the components of the other type.

In step S9, the artificial intelligence can then be used to assess second assessment data sets if the at least one first calibration data set was used in step S8. The second assessment data sets each relate to a component of the same type as the components corresponding to the first assessment data sets, respectively. If the second calibration data sets were used in step S8, the artificial intelligence can be used in step S9 to assess third assessment data sets that relate to components of the other type.

1. A computer-implemented method for assessing structure-borne noise, comprising the following steps:
recording (S3) training data sets of structure-borne noise data, the training data sets each being recorded while a force acts on a component, and the structure-borne noise data depending on the force;
training (S5) an artificial intelligence using the training data sets;
recording (S7) first assessment data sets of structure-borne noise data;
assessing the first assessment data sets using the trained artificial intelligence; and, subsequently
recording at least one first calibration data set of structure-borne noise data;
training (S8) the artificial intelligence using the at least one first calibration data set.

2. The method of claim 1, wherein, prior to training the artificial intelligence using the training data sets, the method further comprising using the artificial intelligence to classify training data sets into clusters (S4) based on a quality of the training data sets, wherein only training data sets with a quality above a limit are used for training the artificial intelligence.

3. The method of claim 1, wherein after training the artificial intelligence, the method includes recording second assessment data sets of structure-borne noise data using the at least one first calibration data set and assessing the second assessment data sets using the artificial intelligence (S9).

4. The method of claim 3, further comprising using the artificial intelligence for assessing the first and/or second assessment data sets as being associated with defect-free components or as being associated with defective components.

5. The method of claim 4, wherein only structure-borne noise data from defect-free components is used to record the at least one first calibration data set.

6. The method of claim 2, further comprising using a first type of component for recording the training data sets, the first and second assessment data sets, and the at least one first calibration data set, and, after the assessment of the second assessment data sets, the method further comprises using a second type of component for recording second calibration data sets, wherein, upon recording of the training data sets, the first and second assessment data sets and the at least one first calibration data set are not used for a second type of component, and wherein the artificial intelligence is trained using the second calibration data sets.

7. The method of claim 6, further comprising using a second type of component for recording third assessment data sets of structure-borne noise data, and assessing the third assessment data sets with the second calibration data sets after the training of the artificial intelligence.

8. The method of claim 7, wherein the assessment of the first, second, and/or third assessment data sets comprises assessing, a movement of the respective component relative to another component, a strength of the respective component, and/or the presence of an imbalance.

9. The method of claim 1, wherein the components are part of motor vehicles.

10. A system comprising a digital electronic storage medium and a digital electronic processing unit, wherein instructions are stored in the storage medium, the processing unit is configured to read out and execute the instructions, and the processing unit is configured to perform the method of claim 1 when executing the instructions.
